(19) United States
(12) Patent Application Publication
(10) Pub. No.: US 2021/0357676 A1
(43) Pub. Date: Nov. 18, 2021

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Eiichiro Kitagawa, Kanagawa (JP)

(21) Appl. No.: 17/318,893

(22) Filed: May 12, 2021

(30) Foreign Application Priority Data
May 18, 2020 (JP) 2020-086982

(51) Int. Cl. G06K 9/46; G06T 7/11

(52) U.S. Cl. CPC G06K 9/4671; G06K 9/4604; G06T 7/11

(57) ABSTRACT

An information processing apparatus determining whether image capturing by an image capturing apparatus is obstructed, the information processing apparatus comprising: a dividing unit configured to divide an input image captured by the image capturing apparatus into a plurality of blocks; a processing determination unit configured to determine whether to perform first detection processing using a reference image corresponding to the image capturing apparatus or second detection processing using a feature of the input image, on each of the blocks; and an obstruction determination unit configured to determine whether the image capturing by the image capturing apparatus is obstructed, based on a detection result of each of the blocks by the first detection processing or the second detection processing.

### BACKGROUND

### Field of the Disclosure

The present disclosure relates to an information processing apparatus, an information processing method, and a storage medium.

### Description of the Related Art

Japanese Patent No. 5235718 discusses a technique that performs image analysis on a captured image to extract a feature amount of the image, and detects, based on a change of the feature amount, an action (camera tampering attempts) obstructing image capturing.

### SUMMARY

The present disclosure is directed to a technique capable of detecting a state where image capturing is obstructed depending on a situation.

According to an aspect of the present disclosure, an information processing apparatus determining whether image capturing by an image capturing apparatus is obstructed, includes a dividing unit configured to divide an input image captured by the image capturing apparatus into a plurality of blocks, a processing determination unit configured to determine whether to perform first detection processing using a reference image corresponding to the image capturing apparatus or second detection processing using a feature amount of the input image, on each of the blocks, and an obstruction determination unit configured to determine whether the image capturing by the image capturing apparatus is obstructed, based on a detection result of each of the blocks by the first detection processing or the second detection processing.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of a system.

FIG. 2 is a block diagram illustrating an example of a hardware configuration of an information processing apparatus.

FIG. 3 is a block diagram illustrating an example of a functional configuration of an image capturing apparatus.

FIG. 4 is a diagram illustrating an example of a method of dividing an image into a plurality of blocks.

FIG. 5 is a flowchart illustrating an example of processing performed by the image capturing apparatus.

FIG. 6 is a flowchart illustrating an example of processing performed by the image capturing apparatus.

FIGS. 7A to 7H are diagrams each illustrating an example of a setting screen for receiving an instruction from a user.

FIGS. 8A and 8B are flowcharts each illustrating an example of processing by the image capturing apparatus.

FIG. 9 is a block diagram illustrating another example of the functional configuration of the image capturing apparatus.

FIG. 10 is a diagram illustrating an example of algorithm to determine detection processing.

### DESCRIPTION OF THE EMBODIMENTS

An exemplary embodiment of the present disclosure is described in detail below with reference to the accompanying drawings. In the present specification and the drawings, components having substantially the same functional configuration are denoted by the same reference numerals, and repetitive descriptions of the components are omitted.

### <System Configuration>

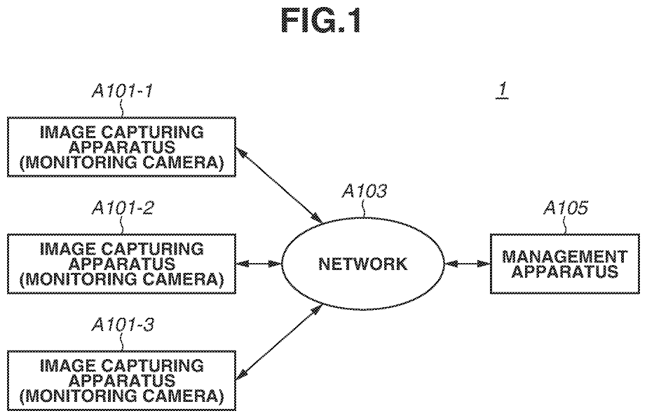

An example of a configuration of a system according to an exemplary embodiment of the present disclosure is described with reference to FIG. 1. A system 1 according to the present exemplary embodiment includes a plurality of image capturing apparatuses A101-1 to A101-3 and a management apparatus A105. Each of the image capturing apparatuses A101-1 to A101-3 and the management apparatus A105 are connected so as to transmit and receive information and data to and from each other through a predetermined network A103.

A type of the network A103 is not particularly limited as long as the network A103 can connect each of the image capturing apparatuses A101-1 to A101-3 with the management apparatus A105. Specific examples of the network A103 include the Internet, a local area network (LAN), a wide area network (WAN), a public line (e.g., telephone line or mobile communication line). Further, other examples of the network A103 include a dedicated line, an asynchronous transfer mode (ATM) line, a frame relay line, a cable television line, and a data broadcasting wireless communication line. Further, the network A103 may be a wireless network or a wired network. In addition, the network A103 may include a plurality of different types of networks. As a specific example, communication between each of the image capturing apparatuses A101-1 to A101-3 and the management apparatus A105 may be relayed by a communication apparatus. In this case, the different types of networks may be applied to the communication between the communication apparatus and each of the image capturing apparatuses A101-1 to A101-3, and the communication between the communication apparatus and the management apparatus A105.

Each of the image capturing apparatuses A101-1 to A101-3 has a detection function to detect an action (e.g., camera tampering attempts) that shields at least a part of a viewing angle to obstruct the image capturing. In the example illustrated in FIG. 1, each of the image capturing apparatuses A101-1 to A101-3 are used as a monitoring camera. In the following description, in a case where the image capturing apparatuses A101-1 to A101-3 are not particularly distinguished from one another, each of the image capturing apparatuses A101-1 to A101-3 is also referred to as an “image capturing apparatus A101”.

The management apparatus A105 is an information processing apparatus that is used for monitoring operation based on images corresponding to image capturing results of the respective image capturing apparatuses A101-1 to A101-3. The management apparatus A105 has functions of, for example, presentation of the image corresponding to the image capturing result of each image capturing apparatus A101, control of the above-described detection function of each image capturing apparatus A101, and reception of notification (e.g., alert) from each image capturing apparatus A101. The management apparatus A105 can be realized by, for example, a personal computer (PC).

The management apparatus A105 includes, for example, a main body performing various kinds of calculations, an output device (e.g., display) presenting information to the user, and an input device (e.g., keyboard and pointing device) receiving an instruction from the user. The management apparatus A105 may receive, from the user, an instruction about setting of each image capturing apparatus A101 through a user interface such as a web browser, and may update setting of the target image capturing apparatus A101 based on the instruction. Further, the management apparatus A105 may receive the image (e.g., moving image or still image) corresponding to the image capturing result from each image capturing apparatus A101, and may present the image to the user through the output device or record the image. Furthermore, the management apparatus A105 may receive notification of an alert and the like from each image capturing apparatus A101, and present information corresponding to the notification to the user through the output device. The various kinds of functions described above may be implemented by, for example, applications installed in the management apparatus A105.

### <Hardware Configuration>

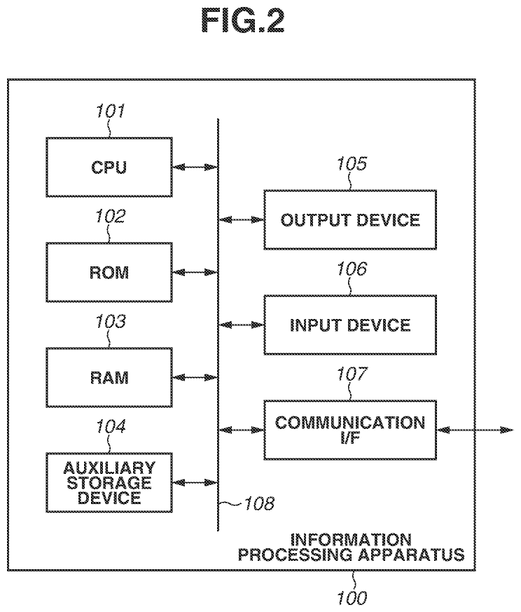

An example of a hardware configuration of an information processing apparatus 100 adoptable as parts relating to execution of the various kinds of calculations of the image capturing apparatus A101 and as the management apparatus A105 is described with reference to FIG. 2.

The information processing apparatus 100 includes a central processing unit (CPU) 101, a read only memory (ROM) 102, and a random access memory (RAM) 103. The information processing apparatus 100 further includes an auxiliary storage device 104 and a communication interface (I/F) 107. The information processing apparatus 100 may include at least any of an output device 105 and an input device 106. The CPU 101, the ROM 102, the RAM 103, the auxiliary storage device 104, the output device 105, the input device 106, and the communication I/F 107 are connected to one another through a bus 108.

The CPU 101 controls various kinds of operation of the information processing apparatus 100. For example, the CPU 101 may control operation of the entire information processing apparatus 100. The ROM 102 stores control programs, a boot program, and other programs executable by the CPU 101. The RAM 103 is a main storage memory of the CPU 101, and is used as a work area or a temporary storage area for loading various kinds of programs.

The auxiliary storage device 104 stores various kinds of data and various kinds of programs. The auxiliary storage device 104 is implemented by a storage device temporarily or persistently storing various kinds of data, such as a nonvolatile memory represented by a hard disk drive (HDD) and a solid state drive (SSD).

The output device 105 is a device outputting various kinds of information, and is used for presentation of the various kinds of information to the user. For example, the output device 105 is implemented by a display device such as a display. In this case, the output device 105 presents the information to the user by displaying various kinds of display information. As another example, the output device 105 may be implemented by a sound output device outputting sound such as voice and electronic sound. In this case, the output device 105 presents the information to the user by outputting sound such as voice and electronic sound. The device adopted as the output device 105 may be appropriately changed depending on a medium used for presentation of information to the user.

The input device 106 is used to receive various kinds of instructions from the user. The input device 106 can be implemented by, for example, a mouse, a keyboard, and a touch panel. Further, as another example, the input device 106 may include a sound collection device such as a microphone, and may collect voice uttered by the user. In this case, when various kinds of analysis processing such as acoustic analysis and natural language processing is performed on the collected voice, contents represented by the voice are recognized as the instruction from the user. Further, a device adopted as the input device 106 may be appropriately changed depending on a method of recognizing the instruction from the user. In addition, a plurality of types of devices may be adopted as the input device 106.

The communication DF 107 is used for communication with an external apparatus through the network. A device adopted as the communication I/F 107 may be appropriately changed depending on a type of a communication path and an adopted communication system.

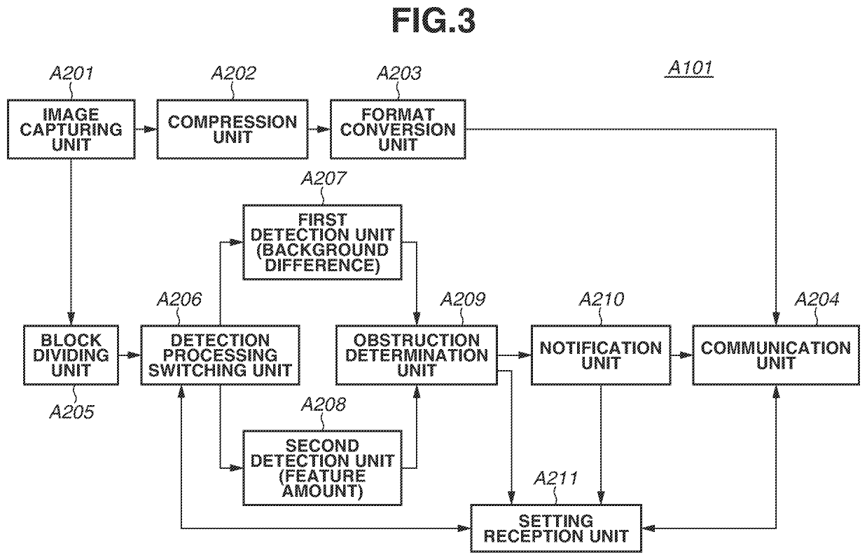

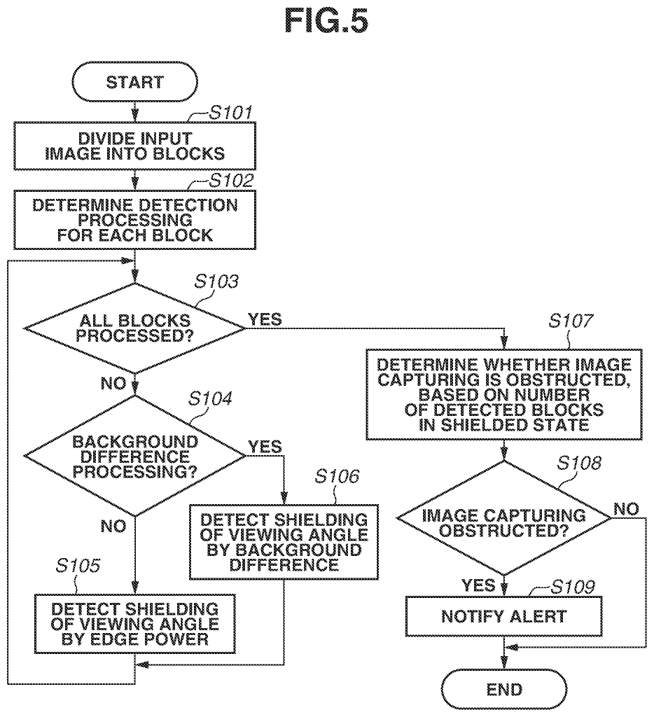

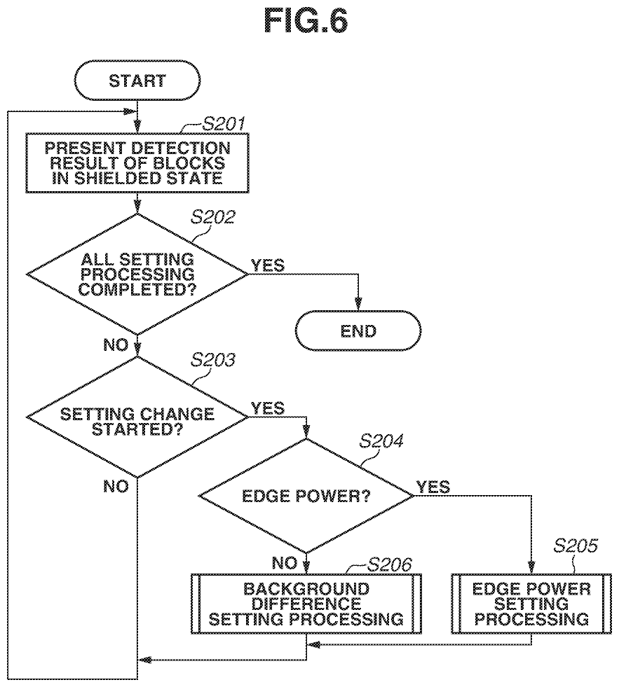

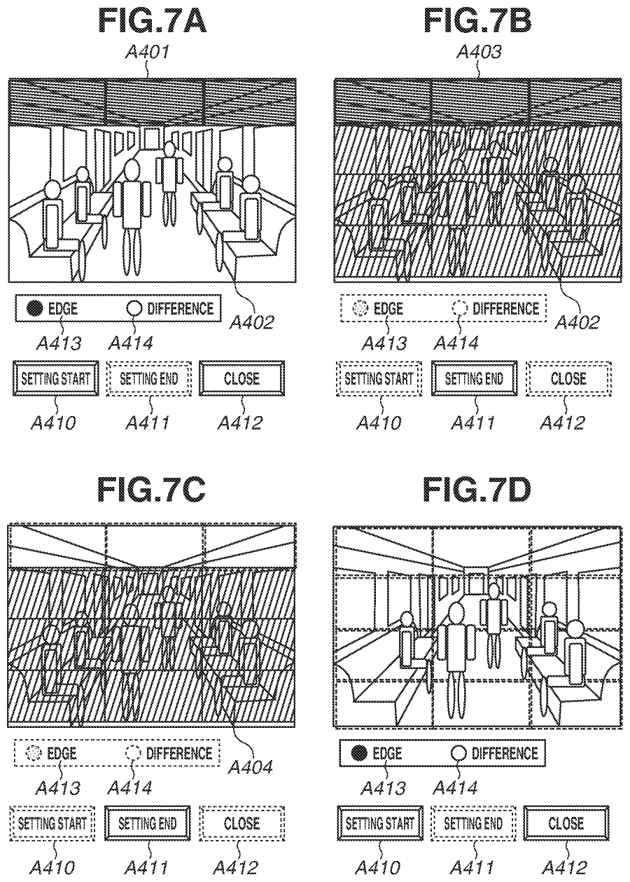

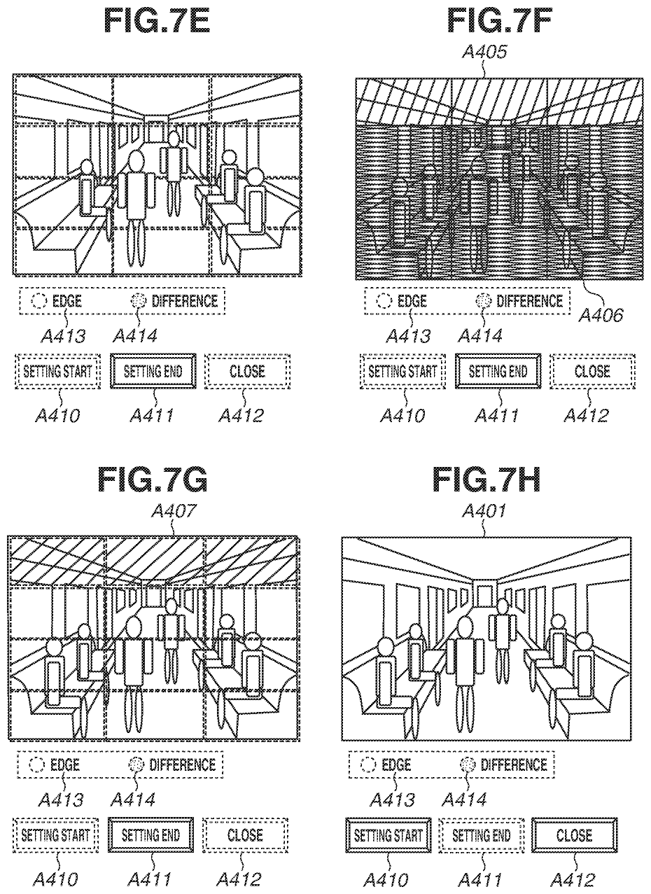

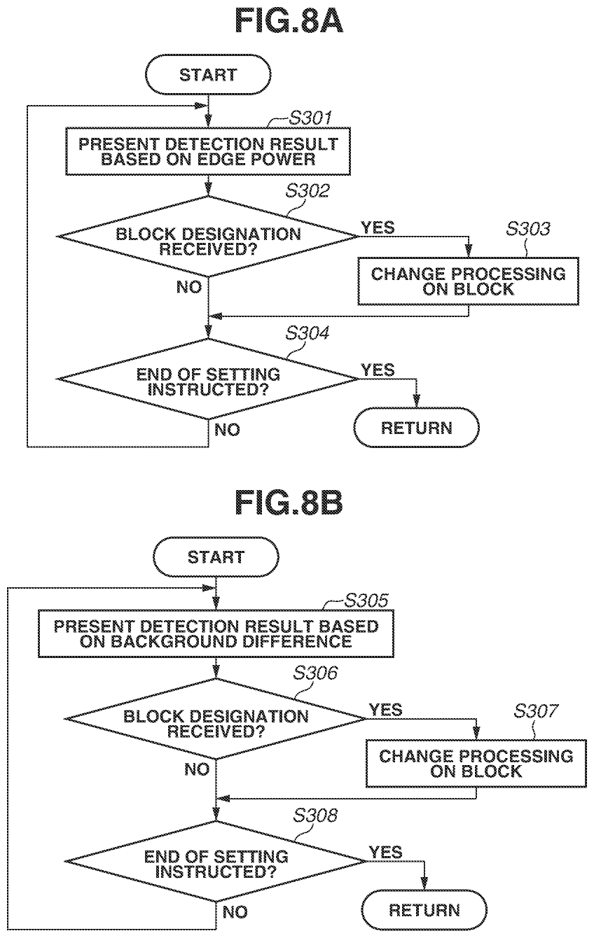

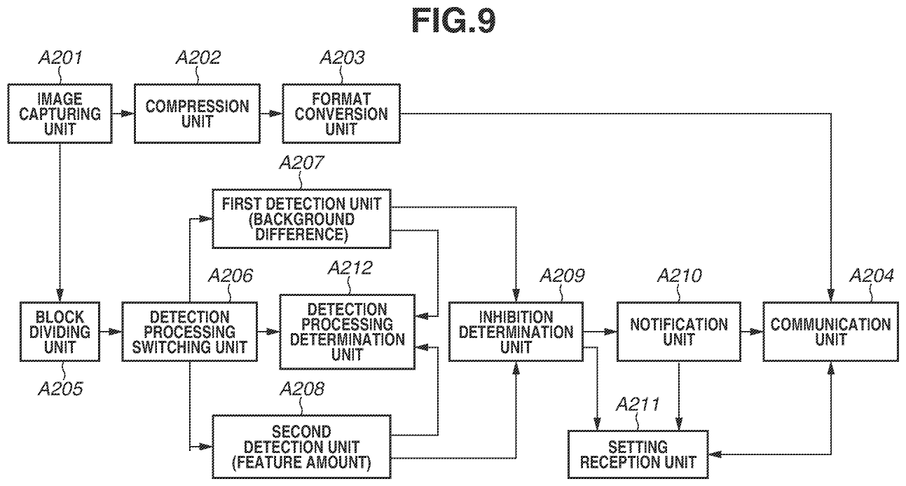

When the CPU 101 loads programs stored in the ROM 102 or the auxiliary storage device 104 to the RAM 103 and executes the programs, functional configurations illustrated in FIG. 3 and FIG. 9 and processing illustrated in FIG. 5, FIG. 6, FIGS. 7A to 7H, and FIGS. 8A and 8B is implemented.

### <Functional Configuration>

An example of a functional configuration of the image capturing apparatus A101 according to the present exemplary embodiment is described with reference to FIG. 3. The image capturing apparatus A101 includes an image capturing unit A201, a compression unit A202, a format conversion unit A203, and a communication unit A204. The image capturing apparatus A101 further includes a block dividing unit A205, a detection processing switching unit A206, a first detection unit A207, a second detection unit A208, an obstruction determination unit A209, a notification unit A210, and a setting reception unit A211.

The image capturing unit A201 guides light of an object incident through an optical system such as a lens, to an image capturing device, photoelectrically converts the light into an electric signal by the image capturing device, and generates image data based on the electric signal.

The compression unit A202 applies encoding processing, compression processing, and other processing on the image data output from the image capturing unit A201, to reduce a data amount of the image data.

The format conversion unit A203 converts the image data, the data amount of which has been reduced by compression, into other image data of a predetermined format. As a specific example, the format conversion unit A203 may convert the target image data into image data of a format more suitable for transmission through the network.

The format conversion unit A203 outputs the format-converted image data to a predetermined output destination. As a specific example, the format conversion unit A203 may output the format-converted image data to the communication unit A204 to transmit the image data to the other apparatus (e.g., management apparatus A105) through the network.

The communication unit A204 transmits and receives information and data to and from the other apparatus through a predetermined network. For example, the communication unit A204 receives information corresponding to an instruction about various kinds of settings received by the management apparatus A105 from the user. In addition, the communication unit A204 transmits an image corresponding to the image capturing result of the image capturing unit A201 and notifies the management apparatus A105 of various kinds of notification information (e.g., alert information).

The block dividing unit A205 divides the image of the image data output from the image capturing unit A201 (i.e., image corresponding to image capturing result of image capturing unit A201) into a plurality of blocks. As a specific example, the block dividing unit A205 may divide the image corresponding to the image capturing result of the image capturing unit A201, into a plurality of blocks each having a rectangular shape.

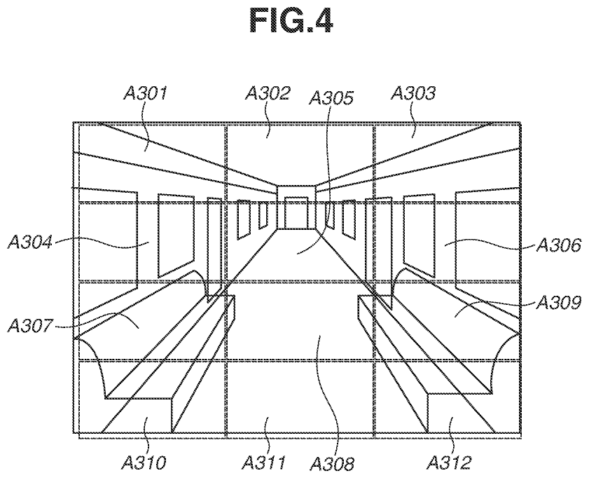

For example, FIG. 4 illustrates an example of a method of dividing the image into the plurality of blocks. In the example illustrated in FIG. 4, the block dividing unit A205 divides the entire image (i.e., entire viewing angle of image capturing unit A201) into 12 blocks each having a uniform size by dividing the entire image into four blocks in vertical direction and into three blocks in a lateral direction. Further, in the example illustrated in FIG. 4, reference numerals A301 to A312 are added to the blocks in order from an upper-left block to a lower-right block, for convenience.

Note that the example illustrated in FIG. 4 is illustrative, and does not limit the method of dividing the image. As a specific example, the image may be divided into a plurality of blocks in such a manner that an area positioned at a center of the image has a size smaller than an area positioned at an end part of the image.

FIG. 3 is referred to again.

The detection processing switching unit A206 selectively switches, based on a predetermined condition, whether to apply processing by the first detection unit A207 described below or processing by the second detection unit A208 described below to each of the plurality of blocks obtained by dividing the image corresponding to the image capturing result of the image capturing unit A201. As a specific example, the detection processing switching unit A206 may acquire, from the setting reception unit A211 described below, the information corresponding to the instruction received by the management apparatus A105 from the user, and may determine processing to be applied to each of the blocks based on the information.

The first detection unit A207 detects occurrence of a state where a partial area corresponding to an input image (e.g., partial image corresponding to each of blocks) in the viewing angle of the image capturing unit A201 is shielded, based on a difference between the input image and a reference image.

The second detection unit A208 detects occurrence of the state where the partial area corresponding to the input image (e.g., partial image corresponding to each of blocks) in the viewing angle of the image capturing unit A201 is shielded, based on a feature amount representing a predetermined image feature extracted from the input image. As a specific example, the second detection unit A208 may extract edge power as the above-described feature amount by applying a Sobel filter to the input image. In this case, the second detection unit A208 may detect occurrence of the state where the partial area corresponding to the input image in the viewing angle of the image capturing unit A201 is shielded, based on uniformity of the input image corresponding to the extracted edge power.

In the following description, the state where the partial area corresponding to the input image (e.g., partial image corresponding to each of blocks) in the viewing angle of the image capturing unit A201 is shielded is also referred to as a “shielded state”, for convenience.

The obstruction determination unit A209 determines whether the image capturing by the image capturing unit A201 is obstructed, based on a detection result of the shielded state of each of the blocks obtained by dividing the image corresponding to the image capturing result of the image capturing unit A201, detected by the first detection unit A207 or the second detection unit A208. As a specific example, the obstruction determination unit A209 may determine whether the image capturing by the image capturing unit A201 is obstructed, based on a ratio of the blocks detected as being shielded to the plurality of blocks obtained by dividing the image corresponding to the image capturing result of the image capturing unit A201.

The notification unit A210 notifies a predetermined notification destination (e.g., management apparatus A105 illustrated in FIG. 1) of information corresponding to the determination result of the obstruction determination unit A209. As a specific example, in a case where it is determined that the image capturing by the image capturing unit A201 is obstructed, the notification unit A210 may notify the management apparatus A105 of information notifying alert (hereinafter, also referred to as alert information).

The setting reception unit A211 receives, from the management apparatus A105, an instruction about various kinds of settings received by the management apparatus A105 from the user, and controls various kinds of settings for operation of the image capturing apparatus A101 in response to the instruction. As a specific example, the setting reception unit A211 may control the detection processing switching unit A206 to switch the shielded state detection processing to be applied to each of the blocks, in response to the instruction from the user received from the management apparatus A105.

Further, the setting reception unit A211 may transmits, to the management apparatus A105, information to present a user interface (UI) for receiving instructions about control of the various kinds of settings from the user (e.g., setting screen) to the user, thereby causing the management apparatus A105 to present the UI. Further, the setting reception unit A211 may control the various kinds of settings for operation of the image capturing apparatus A101 (e.g., setting about switching condition of detection processing switching unit A206), in response to the instruction received by the management apparatus A105 from the user through the above-described UI.

### <Processing>

An example of processing by the image capturing apparatus A101 according to the present exemplary embodiment is described with reference to FIG. 5 while particularly focusing on processing to detect obstruction of the image capturing by the image capturing unit A201. In the example illustrated in FIG. 5, to detect the shielded state of the target block of the second detection unit A208, edge power is used as the feature amount extracted from the block.

In step S101, the block dividing unit A205 divides the image corresponding to the image capturing result of the image capturing unit A201, into a predetermined number of blocks.

In step S102, the detection processing switching unit A206 determines whether to apply the processing by the first detection unit 207 or the processing by the second detection unit A208 to each of the blocks, based on the user instruction notified from the setting reception unit A211. The processing in step S102 is separately described in detail below.

In step S103, the image capturing apparatus A101 determines whether processing in steps S104 to S106 described below has been performed on all of the plurality of blocks obtained by dividing the image corresponding to the image capturing result of the image capturing unit A201. In a case where the image capturing apparatus A101 determines in step S103 that the processing in steps S104 to S106 has not been performed on all of the plurality of blocks obtained by dividing the image corresponding to the image capturing result of the image capturing unit A201 (NO in step S103), the processing proceeds to step S104.

In step S104, the detection processing switching unit A206 confirms whether application of the processing by the first detection unit A207 (shielded state detection processing based on background difference) to the target block is determined in step S102.

In step S104, in a case where the detection processing switching unit A206 confirms that the processing by the first detection unit A207 (shielded state detection processing based on background difference) is applied to the target block (YES in step S104), the processing proceeds to step S106. In step S106, the detection processing switching unit A206 requests the first detection unit A207 to perform the processing on the target block. The first detection unit A207 detects the shielded state of a partial area corresponding to the target block in the viewing angle of the image capturing unit A201 by using a background difference based on comparison between a partial image corresponding to the target block and a reference image.

On the other hand, in step S104, in a case where the detection processing switching unit A206 confirms that the processing by the first detection unit A207 (shielded state detection processing based on background difference) is not applied to the target block (NO in step S104), the processing proceeds to step S105. In step S105, the detection processing switching unit A206 requests the second detection unit A208 to perform the processing on the target block. The second detection unit A208 detects the shielded state of the partial area corresponding to the target block in the viewing angle of the image capturing unit A201 by using edge power extracted from the partial image corresponding to the target block.

The image capturing apparatus A101 performs the processing in steps S104 to S106 on all of the blocks obtained by dividing the image corresponding to the image capturing result of the image capturing unit A201, in the above-described manner.

In a case where the image capturing apparatus A101 determines in step S103 that the processing in steps S104 to S106 has been already performed on all of the plurality of blocks obtained by dividing the image corresponding to the image capturing result of the image capturing unit A201 (YES in step S103), the processing proceeds to step S107.

In step S107, the obstruction determination unit A209 determines whether the image capturing by the image capturing unit A201 is obstructed based on the number of blocks detected as being shielded among all of the blocks obtained by dividing the image corresponding to the image capturing result of the image capturing unit A201. More specifically, the obstruction determination unit A209 calculates a ratio of the blocks detected as being shielded to all of the blocks, and compares the ratio with a threshold. In a case where the calculated ratio exceeds the threshold, the obstruction determination unit A209 determines that the image capturing by the image capturing unit A201 is obstructed.

In step S108, the obstruction determination unit 209 confirms whether it is determined in step S107 that the image capturing by the image capturing unit A201 is obstructed.

In step S108, in a case where the obstruction determination unit A209 confirms that the image capturing by the image capturing unit A201 is obstructed (YES in step S108), the processing proceeds to step S109. In step S109, the notification unit A210 notifies the management apparatus A105 of detection of the state where the image capturing by the image capturing unit A201 is obstructed.

On the other hand, in step S108, in a case where the obstruction determination unit A209 confirms that the image capturing by the image capturing unit A201 is not obstructed (NO in step S108), the series of processing illustrated in FIG. 5 ends. In this case, the processing in step S109 is not performed.

Next, an example of the processing by the detection processing switching unit A206 to determine whether to apply the processing by the first detection unit A207 or the processing by the second detection unit A208 to the target block, illustrated in step S102 of FIG. 5 is described with reference to FIG. 6 and FIGS. 7A to 7H. FIG. 6 is a flowchart illustrating a flow of a series of processing. FIGS. 7A to 7H each illustrate an example of a setting screen that presents information to the user and receives designation of various kinds of settings from the user.

In step S201, the setting reception unit A211 transmits a screen that presents the detection result of the shielded state of each of the blocks based on the current setting to each of the blocks, to the management apparatus A105 through the communication unit A204, and causes the management apparatus A105 to present the screen.

FIG. 7A illustrates an example of the above-described screen presented by the management apparatus A105 based on the instruction from the setting reception unit A211. The image corresponding to the image capturing result of the image capturing unit A201 is displayed on an upper part of the screen. An area A401 illustrated on the image indicates an area corresponding to blocks detected as being shielded, based on the current setting. In the screen illustrated in FIG. 7A, hatching (mask) in a predetermined presentation form is superimposed on the area A401 to highlight the target blocks.

A start button A410 is a button for receiving an instruction to start setting about the shielded state detection, from the user. An end button A411 is a button for receiving an instruction to end the setting about the shielded state detection, from the user. A close button A412 is a button for receiving an instruction to close the setting screen, from the user. Radio buttons A413 and A414 are interfaces for receiving selection of a method to detect the shielded state of each of the blocks, from the user. In a case where the radio button A413 is selected, the shielded state detection processing based on the edge power by the second detection unit A208 is applied to the target block. In a case where the radio button A414 is selected, the shielded state detection processing based on the background difference by the first detection unit A207 is applied to the target block.

As illustrated in FIG. 7A, in a state where the detection result is presented, the end button A411 is invalid, and the start button A410, the close button A412, and the radio buttons A413 and A414 can receive operation from the user.

In step S202, the management apparatus A105 determines whether an instruction to complete all setting processing has been received from the user. As a specific example, in a case where the close button A412 is pressed, the management apparatus A105 may recognize that the instruction to complete all setting processing has been received from the user.

In a case where the management apparatus A105 determines in step S202 that the instruction to complete all setting processing has been received from the user (YES in step S202), the series of processing illustrated in FIG. 6 ends.

On the other hand, in a case where the management apparatus A105 determines in step S202 that the instruction to complete all setting processing has not been received from the user (NO in step S202), the processing proceeds to step S203. In step S203, the management apparatus A105 determines whether an instruction to start setting about the shielded state detection has been received from the user. As a specific example, in a case where the start button A410 is pressed, the management apparatus A105 may recognize that the instruction to start the setting about the shielded state detection has been received from the user.

In a case where the management apparatus A105 determines in step S203 that the instruction to start the setting about the shielded state detection has not been received (NO in step S203), the processing proceeds to step S201. In this case, the series of processing from step S201 illustrated in FIG. 6 is performed again.

On the other hand, in a case where the management apparatus A105 determines in step S203 that the instruction to start the setting about the shielded state detection has been received (YES in step S203), the processing proceeds to step S204. In step S204, the management apparatus A105 determines whether, out of the method based on the edge power and the method based on the background difference, the method based on the edge power has been selected as the method to detect the shielded state. As a specific example, in a case where the radio button A413 associated with the method based on the edge power is designated out of the radio buttons A413 and A414, the management apparatus A105 may recognize that the method based on the edge power has been selected.

In a case where the management apparatus A105 determines in step S204 that the method based on the edge power has been selected as the method to detect the shielded state (e.g., in a case where the radio button A413 is designated) (YES in step S204), the processing proceeds to step S205. In step S205, the management apparatus A105 performs setting processing relating to the shielded state detection by the method based on the edge power. The processing is separately described in detail below with reference to FIG. 8A.

On the other hand, in a case where the management apparatus A105 determines in step S204 that the method based on the edge power has not been selected as the method to detect the shielded state (e.g., in a case where the radio button A414 is designated) (NO in step S204), the processing proceeds to step S206. In step S206, the management apparatus A105 performs setting processing relating to the shielded state detection by the method based on the background difference. The processing is separately described in detail below with reference to FIG. 8B.

The management apparatus A105 performs the series of processing illustrated in FIG. 6 in the above-described manner until the management apparatus A105 determines in step S202 that the instruction to complete all setting processing has been received from the user.

Next, an example of the setting processing relating to the shielded state detection by the method based on the edge power, described as the processing in step S205 of FIG. 6 is described with reference to FIGS. 7A to 7D and FIG. 8A. FIG. 8A is a flowchart illustrating a flow of the series of processing.

In step S301, the setting reception unit A211 transmits a screen that presents a detection result of the shielded state of each of the blocks based on the edge power, to the management apparatus A105 through the communication unit A204, and causes the management apparatus A105 to present the screen.

FIG. 7B illustrates an example of the above-described screen presented by the management apparatus A105 based on the instruction from the setting reception unit A211. An area A402 illustrated on the image corresponding to the image capturing result of the image capturing unit A201 indicates an area corresponding to blocks set as execution targets of the shielded state detection processing based on the edge power. Further, an area A403 illustrated on the above-described image indicates an area corresponding to blocks detected as being shielded, based on the edge power. In the screen illustrated in FIG. 7B, hatching (mask) in a predetermined presentation form is superimposed on each of the areas A402 and A403 to highlight the target blocks.

It is found from the screen illustrated in FIG. 7B that erroneous detection of the shielded state detection based on the edge power has occurred in blocks corresponding to a vicinity of a ceiling.

In the screen illustrated in FIG. 7B, execution and inexecution of the shielded state detection processing based on the edge power can be selectively switched in response to an instruction to designate each of the presented blocks (e.g., designation operation using pointing device).

In step S302, the management apparatus A105 determines whether the instruction to designate a block has been received from the user through the above-described screen.

In a case where the management apparatus A105 determines in step S302 that the instruction to designate a block has been received from the user (YES in step S302), the processing proceeds to step S303. In step S303, the management apparatus A105 requests the image capturing apparatus A101 that has captured the image displayed on the screen, to switch execution and inexecution of the shielded state detection processing based on the edge power on the designated block. The setting reception unit A211 of the image capturing apparatus A101 instructs the detection processing switching unit A206 to switch execution and inexecution of the shielded state detection processing based on the edge power on the block designated by the user, in response to the request from the management apparatus A105. The detection processing switching unit A206 switches execution and inexecution of the shielded state detection processing based on the edge power on the target block, in response to the instruction from the setting reception unit A211.

In the present exemplary embodiment, in a case where the shielded state detection processing based on the edge power on the target block is switched to inexecution, the shielded state detection processing based on the background difference is performed on the target block.

For example, a screen illustrated in FIG. 7C illustrates an example of a screen presented based on a switching result of execution and inexecution of the shielded state detection processing based on the edge power on the block designated by the user. An area A404 illustrated on the image corresponding to the image capturing result of the image capturing unit A201 indicates an area corresponding to blocks set as execution targets of the shielded state detection processing based on the edge power.

As can be seen from comparison between the screen illustrated in FIG. 7C and the screen illustrated in FIG. 7B, erroneous detection occurred in the blocks corresponding to the vicinity of the ceiling in the screen illustrated in FIG. 7B is eliminated in the screen illustrated in FIG. 7C.

On the other hand, in a case where the management apparatus A105 determines in step S302 that the instruction to designate the block has not been received from the user (NO in step S302), the processing proceeds to step S304. In this case, the processing in step S303 is not performed.

In step S304, the management apparatus A105 determines whether an instruction to end setting about the shielded state detection has been received from the user. As a specific example, in a case where the end button A411 is pressed, the management apparatus A105 may recognize that the instruction to end the setting about the shielded state detection has been received from the user.

In a case where the management apparatus A105 determines in step S304 that the instruction to end the setting about the shielded state detection has been received from the user (YES in step S304), the series of processing illustrated in FIG. 8A ends.

For example, a screen illustrated in FIG. 7D illustrates an example of a screen presented after the series of processing illustrated in FIG. 8A is completed. As presented in the screen, it is found that erroneous detection occurred at a timing when the screen illustrated in FIG. 7B is presented is eliminated at a timing when the screen illustrated in FIG. 7D is presented.

On the other hand, in a case where the management apparatus A105 determines in step S304 that the instruction to end the setting about the shielded state detection has not been received from the user (NO in step S304), the processing proceeds to step S301.

The management apparatus A105 performs the series of processing illustrated in FIG. 8A in the above-described manner until the management apparatus A105 determines in step S304 that the instruction to end the setting about the shielded state detection has been received from the user.

Next, an example of the setting processing relating to the shielded state detection by the method based on the background difference, described as the processing in step S206 of FIG. 6 is described with reference to FIGS. 7E to 7H and FIG. 8B. FIG. 8B is a flowchart illustrating a flow of the series of processing.

For example, a screen illustrated in FIG. 7E illustrates an example of a screen that receives, from the user, the instruction to switch execution and inexecution of the shielded state detection processing based on the background difference on each of the blocks. In the screen illustrated in FIG. 7E, the shielded state detection processing based on the background difference on each of the blocks is set to inexecution.

On the other hand, a screen illustrated in FIG. 7F illustrates another example of the screen that receives, from the user, the instruction to switch execution and inexecution of the shielded state detection processing based on the background difference on each of the blocks. In the screen illustrated in FIG. 7F, the shielded state detection processing based on the background difference on each of the blocks is set to execution.

In step S305, the setting reception unit A211 transmits a screen that presents a detection result of the shielded state of each of the blocks based on the background difference, to the management apparatus A105 through the communication unit A204, and causes the management apparatus A105 to present the screen.

In FIG. 7F, an area A405 illustrated on the image corresponding to the image capturing result of the image capturing unit A201 indicates an area corresponding to blocks set as execution targets of the shielded state detection processing based on the background difference. Further, an area A406 illustrated on the above-described image indicates an area corresponding to blocks detected as being shielded, based on the background difference. In the screen illustrated in FIG. 7F, hatching (mask) in a predetermined presentation form is superimposed on each of the areas A405 and A406 to highlight the target blocks.

In other words, it is found from the screen illustrated in FIG. 7F that erroneous detection of the shielded state detection based on the background difference has occurred in blocks (nine blocks on lower part) corresponding to a vicinity of persons and windows.

In the screen illustrated in FIG. 7F, execution and inexecution of the shielded state detection processing based on the background difference can be selectively switched by an instruction to designate each of the presented blocks (e.g., designation operation using pointing device).

In step S306, the management apparatus A105 determines whether an instruction to designate a block has been received from the user through the above-described screen.

In a case where the management apparatus A105 determines in step S306 that the instruction to designate a block has been received from the user (YES in step S306), the processing proceeds to step S307. In step S307, the management apparatus A105 requests the image capturing apparatus A101 that has captured the image displayed on the screen, to switch execution and inexecution of the shielded state detection processing based on the background difference on the designated block. The setting reception unit A211 of the image capturing apparatus A101 instructs the detection processing switching unit A206 to switch execution and inexecution of the shielded state detection processing based on the background difference on the block designated by the user, in response to the request from the management apparatus A105. The detection processing switching unit A206 switches execution and inexecution of the shielded state detection processing based on the background difference on the target block, in response to the instruction from the setting reception unit A211.

In the present exemplary embodiment, in a case where the shielded state detection processing based on the background difference on the target block is switched to inexecution, the shielded state detection processing based on the edge power is performed on the target block.

For example, a screen illustrated in FIG. 7G illustrates an example of a screen presented based on a switching result of execution and inexecution of the shielded state detection processing based on the background difference on the block designated by the user. An area A407 illustrated on the image corresponding to the image capturing result of the image capturing unit A201 indicates an area corresponding to blocks set as execution targets of the shielded state detection processing based on the background difference.

As can be seen from the comparison between the screen illustrated in FIG. 7G and the screen illustrated in FIG. 7E, erroneous detection occurred in the blocks corresponding to the vicinity of persons and windows in the screen illustrated in FIG. 7E is eliminated in the screen illustrated in FIG. 7G.

On the other hand, in a case where the management apparatus A105 determines in step S306 that the instruction to designate the block has not been received from the user (NO in step S306), the processing proceeds to step S308. In this case, the processing in step S307 is not performed.

In step S308, the management apparatus A105 determines whether an instruction to end the setting about the shielded state detection has been received from the user. As a specific example, in the case where the end button A411 is pressed, the management apparatus A105 may recognize that the instruction to end the setting about the shielded state detection has been received from the user.

In a case where the management apparatus A105 determines in step S308 that the instruction to end the setting about the shielded state detection has been received from the user (YES in step S308), the series of processing illustrated in FIG. 8B ends.

For example, a screen illustrated in FIG. 7H illustrates an example of a screen presented after the series of processing illustrated in FIG. 8B is completed. As presented in the screen, it is found that erroneous detection occurred at a timing when the screen illustrated in FIG. 7E is presented is eliminated at a timing when the screen illustrated in FIG. 7H is presented.

On the other hand, in a case where the management apparatus A105 determines in step S308 that the instruction to end the setting about the shielded state detection has not been received from the user (NO in step S308), the processing returns to step S305.

The management apparatus A105 performs the series of processing illustrated in FIG. 8B in the above-described manner until the management apparatus A105 determines in step S308 that the instruction to end the setting about the shielding state detection has been received from the user.

Applying the above-described processing makes it possible to selectively switch the processing to be applied to the determination whether each of the blocks is shielded, between the processing based on the feature amount (e.g., edge power) and the processing based on the background difference depending on the situation of the time. Such a mechanism makes it possible to improve detection accuracy of the state where the image capturing by the image capturing unit A201 is obstructed, depending on the situation of the time (e.g., scene to be monitored).

### <Modification>

Subsequently, a modification of the present exemplary embodiment is described. In the above-described exemplary embodiment, the processing to be applied to each of the blocks is manually set by the user operation. In contrast, in the present modification, an example of a mechanism in which the image capturing apparatus A101 automatically set the processing to be applied to each of the blocks obtained by dividing the image corresponding to the image capturing result of the image capturing unit A201 by using a detection result of the shielded state of each of the blocks, is described.

### <Functional Configuration>

First, an example of a functional configuration of the image capturing apparatus A101 according to the present modification is described with reference to FIG. 9. The image capturing apparatus A101 according to the present modification is different from the example illustrated in FIG. 3 that the image capturing apparatus A101 includes a detection processing determination unit A212, and the detection processing switching unit A206 switches the processing to be applied to the target block based on an instruction from the detection processing determination unit A212. In FIG. 9, reference numerals similar to the reference numerals in FIG. 3 indicate components similar to the components denoted by the reference numerals in FIG. 3. With this in mind, in the following description, the functional configuration of the image capturing apparatus A101 according to the present modification is described while focusing on differences from the example illustrated in FIG. 3.

The detection processing determination unit A212 receives feedback of the detection result of the shielded state of the block based on the background difference by the first detection unit A207 and feedback of the detection result of the shielded state of the block based on the feature amount (e.g., edge power) by the second detection unit A208. The detection processing determination unit A212 determines whether to apply the detection processing based on the background difference or the detection processing based on the feature amount, to the target block, based on the feedback (i.e., detection result described above).

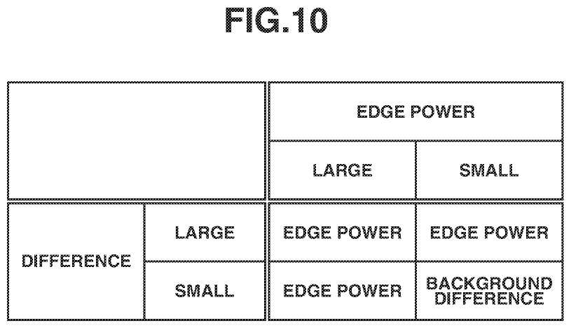

For example, FIG. 10 illustrates an example of algorithm for the detection processing determination unit A212 to determine the detection processing to be applied to the target block. In the example illustrated in FIG. 10, the second detection unit A208 uses the edge power as the feature amount for detecting the shielded state of each of the blocks.

The detection processing determination unit A212 determines the detection processing to be applied to each of the blocks based on whether the background difference acquired for each of the blocks is larger than or smaller than a threshold, and whether the feature amount extracted from each of the blocks is larger than or smaller than a threshold. More specifically, the detection processing determination unit A212 basically determines the processing based on the edge power as the applied processing, and in a case where the edge power is smaller than the threshold and the background difference is smaller than the threshold, the detection processing determination unit A212 determines the detection processing based on the background difference as the applied processing. Further, the detection processing determination unit A212 controls the detection processing switching unit A206 to switch the processing to be applied to the target block, based on the determination result of the detection processing applied to the target block.

Applying the above-described control makes it possible to automatically and selectively switch the processing to be applied for determination whether each of the blocks is shielded, between the processing based on the feature amount (e.g., edge power) and the processing based on the background difference, depending on the situation of the time. Such a mechanism makes it possible to improve the detection accuracy of the state where the image capturing by the image capturing unit A201 is obstructed, depending on the situation of the time (e.g., scene to be monitored).

### Other Exemplary Embodiments

The present disclosure can be realized by supplying programs implementing one or more functions of the above-described exemplary embodiment to a system or an apparatus through a network or a recording medium, and causing one or more processors of a computer in the system or the apparatus to read out and execute the programs. Further, the present disclosure can be realized by a circuit (e.g., application specific integrated circuit (ASIC)) implementing one or more functions of the above-described exemplary embodiment.

Further, the configurations described with reference to FIG. 3 and FIG. 9 are merely examples, and are not intended to limit the functional configuration of the image capturing apparatus A101 according to the present modification. For example, among the components of the image capturing apparatus A101, some of the components may be provided outside the image capturing apparatus A101.

As a specific example, the components A205 to A211 relating to detection of the state where the image capturing by the image capturing unit A201 is obstructed may be provided outside the image capturing apparatus A101. In this case, an apparatus including the components A205 to A211 relating to detection of the state where the image capturing by the image capturing unit A201 is obstructed corresponds to an example of the “information processing apparatus” according to the present exemplary embodiment.

Further, as another example, among the components of the image capturing apparatus A101, a load of the processing by at least some of the components may be distributed to a plurality of apparatuses.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-086982, filed May 18, 2020, which is hereby incorporated by reference herein in its entirety.

What is claimed is:

1. An information processing apparatus determining whether image capturing by an image capturing apparatus is obstructed, the information processing apparatus comprising:
a dividing unit configured to divide an input image captured by the image capturing apparatus into a plurality of blocks;
a processing determination unit configured to determine whether to perform first detection processing using a reference image corresponding to the image capturing apparatus or second detection processing using a feature of the input image, on each of the blocks; and
an obstruction determination unit configured to determine whether the image capturing by the image capturing apparatus is obstructed, based on a detection result of each of the blocks by the first detection processing or the second detection processing.

2. The information processing apparatus according to claim 1, wherein the processing determination unit determines whether to perform the first detection processing or the second detection processing on each of the blocks, based on a user instruction received for each of the blocks.

3. The information processing apparatus according to claim 1, wherein the processing determination unit determines whether to perform the first detection processing or the second detection processing on each of the blocks, based on the detection result by the first detection processing and the detection result by the second detection processing.

4. The information processing apparatus according to claim 3, wherein the processing determination unit determines whether to perform the first detection processing or the second detection processing on each of the blocks, based on the feature in the second detection processing and a difference between the input image and the reference image in the first detection processing.

5. The information processing apparatus according to claim 4, wherein, in a case where the feature extracted from the input image is smaller than a threshold and the difference between the input image and the reference image is smaller than a threshold, the first detection processing is determined.

6. The information processing apparatus according to claim 1, further comprising:
a first detection unit configured to perform the first detection processing that detects occurrence of a state where a partial area corresponding to the input image in a viewing angle of the image capturing apparatus is shielded, based on a difference between the input image and the reference image; and
a second detection unit configured to perform the second detection processing that detects occurrence of the state where the partial area corresponding to the input image in the viewing angle of the image capturing apparatus is shielded, based on the feature amount extracted from the input image.

7. An information processing method performed by an information processing apparatus to determine whether image capturing by an image capturing apparatus is obstructed, the information processing method comprising:
dividing an input image captured by the image capturing apparatus into a plurality of blocks;
determining whether to perform first detection processing using a reference image corresponding to the image capturing apparatus or second detection processing using a feature of the input image, on each of the blocks; and
determining whether the image capturing by the image capturing apparatus is obstructed, based on a detection result of each of the blocks by the first detection processing or the second detection processing.

8. A non-transitory storage medium storing a program causing a computer to execute an information processing method to determine whether image capturing by an image capturing apparatus is obstructed, the information processing method comprising:
dividing an input image captured by the image capturing apparatus into a plurality of blocks;
determining whether to perform first detection processing using a reference image corresponding to the image capturing apparatus or second detection processing using a feature of the input image, on each of the blocks; and
determining whether the image capturing by the image capturing apparatus is obstructed, based on a detection result of each of the blocks by the first detection processing or the second detection processing.
